(19) United States
(12) Patent Application Publication
(10) Pub. No.: US 2010/0138461 A1
(43) Pub. Date: Jun. 3, 2010

(54) APPARATUS FOR MANAGING NEW DEVICE COMPONENT OF MOBILE TERMINAL AND METHOD OF THE SAME

(75) Inventors: Chanyong LEE, Daejeon-City (KR); Namhoon PARK, Daejeon-City (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon- City (KR)

(21) Appl. No.: 12/629,125

(22) Filed: Dec. 2, 2009

(30) Foreign Application Priority Data
Dec. 3, 2008 (KR) 10-2008-0121646
Aug. 27, 2009 (KR) 10-2009-0079730

(51) Int. Cl. G06F 17/30

(52) U.S. Cl. 707/828; 707/E17.01

(57) ABSTRACT

Provided is an apparatus for managing new device components of a mobile terminal which arranges and manages a component related file defined in a domain profile in a file directory structure and additionally arranges the corresponding device component related file corresponding to a new device when changing a mode to the new device during the operation of the corresponding domain system in the file directory, thereby reconfiguring the components within the domain system in the file directory.

### RELATED APPLICATIONS

The present application claims priority to Korean Patent Application Serial Number 10-2008-0121646, filed on Dec. 3, 2008 and Korean Patent Application Serial Number 10-2009-079730, filed on Aug. 27, 2009, the entirety of which are hereby incorporated by reference.

### BACKGROUND OF THE INVENTION

1. Field of the Invention

The present invention relates to an apparatus for managing new device components of a mobile terminal and a method of the same, and in particular, an apparatus for managing new device components of a mobile terminal capable of installing new device components in real time while operating the components within a domain system of the mobile terminal and a method of the same.

2. Description of the Related Art

A software communication architecture (SCA) is a standardized communication software structure to largely improve interoperability between communication systems and to reduce development and distribution costs, which was proposed by the Joint Tactical Radio System (JTRS) and Joint Program Office (JPO), USA.

The SCA adopts a real time operating system (OS) and a common object request broker architecture (CORBA), which is an industrial standard of a distributed object model, as middleware to provide an integrated environment having different types of hardware and software. Herein, the SCA is an independent system design framework rather than a standard limited to a specific system.

The SCA binds several components into one package by an application that performs one waveform function and installs and arranges it in the hardware and then operates it. A representative example adopting the SCA may include a software defined radio (SDR) terminal system. The SDR terminal system adopts the SCA as a standard for a software framework.

The SDR terminal removes application components, which are already in operation, from the corresponding devices when reconfiguring the system according to a mode change and new application components, which will be operated according to a new mode, and are installed in the SDR terminal. Thereafter, the SDR terminal finds devices that have the installed application components operating therein and arranges and operates application components in the corresponding devices, thereby reconfiguring the system.

In order to support the method, a naming server that has information on all the components (domain manager, device manager, devices, services, and application components), a domain manager that manages information on device manager components, devices, services, and application components, etc., in a domain, and a device manager that manages logical devices and services should be essentially operated within the SDR terminal.

In addition, the SDR terminal operates the device components that manage devices managed by the device manager and the service management components that manage services and then operates the application components according to the mode change, thereby performing a function of reconfiguring the system.

As described above, prior to operating the application components required to reconfigure the SCA-based system, the naming server that is a management component, the domain manager, the device manager component, the device component, and the service management component are previously operated, such that the time consumed to reconfigured the system becomes long.

In order to solve the above problem, a need exists for a method of additionally installing new device components in real time during the operation of the system. However, the existing SCA-based SDR terminal system cannot additionally install new device components in real time during the operation of the system.

### SUMMARY OF TEE INVENTION

The present invention proposes to solve the above problems. It is an object of the present invention to provide an apparatus for managing new device components of a mobile terminal capable of efficiently operating resources within a domain system by additionally installing device components in real time while operating the components within the domain system of the mobile terminal and a method of the same.

In order to achieve the above objects, there is provided with an apparatus for managing new device components of a mobile terminal according to the present invention, including: a domain profile that defines a component related file operated within a domain system of a corresponding mobile terminal; a device component that manages devices within the domain system; and a device manager component that reconfigures components within the domain system by arranging and managing the component related file defined in the domain profile as a file directory structure and additionally arranging a device component related file corresponding to the new device in the file directory at the time of changing a mode to the new device during the operation of the domain system.

The device manager component stores the device component related file in the corresponding directory by confirming whether there is a directory for additionally arranging the device component related file of the new device in the file directory at the time of adding the new device.

The device manager component additionally generates the file directory in which the device component related file is arranged when there is no directory for additionally arranging the corresponding device component related file.

The device component related file includes at least one of a device configuration descriptor file, an XML file, and an execution file.

The device configuration descriptor file includes at least one of initial operating information of the device manager components and new device information.

The XML file includes a software package descriptor file, a software component descriptor file, and a properties descriptor file.

The device manager component parallely arranges the device component descriptor file, the XML file, and the execution file in the corresponding file directory.

In order to achieve the above objects, there is provided with a method for managing new device components of a mobile terminal according to the present invention, including: arranging and managing a component related file operated within a domain system of a corresponding mobile terminal as a file directory structure; additionally arranging a device component related file corresponding to the new device in the file directory at the time of changing a mode to the new device during the operation of the domain system; and operating the device components by executing the corresponding device component related file additionally arranged in the file directory.

The method further includes, prior to additionally arranging in the file directory, confirming whether there is a directory to additionally arrange the corresponding device component related file.

When there is a directory to additionally arrange the corresponding device component related file, the method further includes copying the device component related file and storing it in the corresponding directory.

When there is no directory in which the corresponding device component related file is additionally arranged, the method further includes additionally generating a file directory to arrange the device component related file.

The device component related file includes at least one of a device configuration descriptor file, an XML file, and an execution file.

The device configuration descriptor file includes at least one of initial operating information of the device manager components and new device information.

The XML file includes a software package descriptor file, a software component descriptor file, and a properties descriptor file.

The additionally arranging parallely arranges the device component descriptor file, the XML file, and the execution file in the corresponding file directory.

With the present invention, when the device components managed in the domain system of the mobile terminal are added, the corresponding device components can be added in real time during the operation of the domain system.

In addition, only the corresponding device components are added while the existing files are maintained without needing to reconfigure all the management components within the domain system, making it possible to efficiently operate the system resources.

Moreover, there are advantages in that the installation time of the new components can be shortened and power consumption can be minimized when the components are reconfigured.

Further, the parsing method can be simplified and the parsing time can be minimized, by installing the device components using the SPD XML parsing method during the operation of the domain system.

### BRIEF DESCRIPTION OF THE DRAWINGS

FIG. 1 is a block diagram showing a system configuration applied to a mobile terminal according to an embodiment of the present invention;

FIGS. 2 and 3 are exemplified diagrams showing a file directory structure according to an embodiment of the present invention; and

FIGS. 4 and 5 are flow charts showing operational flows of a method for managing new device components of a mobile terminal according to an embodiment of the present invention.

### DETAILED DESCRIPTION OF THE PREFERRED EMBODIMENTS

Hereinafter, exemplary embodiments of the present invention will be described with reference to the accompanying drawings.

The present invention relates to an apparatus for managing new device components of a mobile terminal and a method of the same. The following embodiments describe a case where a mobile terminal is an SCA-based SDR terminal as an example but are not limited thereto.

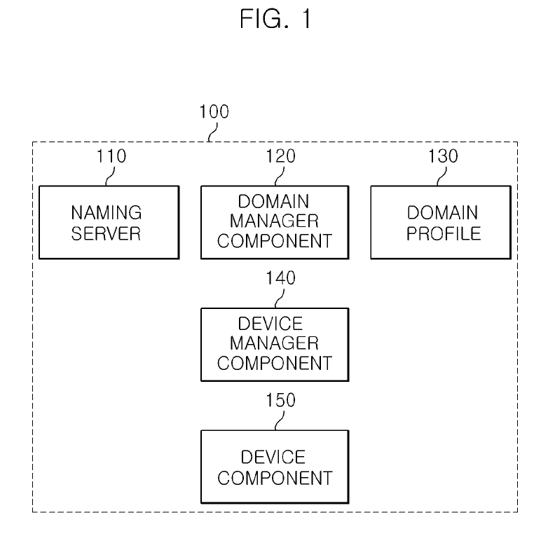

FIG. 1 is a block diagram showing a configuration of an SCA-based SDR terminal system according to one embodiment of the present invention.

In particular, the present invention relates to an apparatus and a method for installing new device components within a terminal in real time while operating when a method for managing devices in a software communication architecture (SCA)-based software defined radio (SDR) terminal system is changed and thus, device components for managing it are added.

Referring to FIG. 1, the SCA-based SDR terminal system according to the present invention is configured to include a naming server 110, a domain manager component 120, a domain profile 130, a device manager component 140, and a device component 150.

The naming server 100 registers each component when the domain manager component 120, the device manager component 140, and the device component 150 are operated. Therefore, information on specific components can be obtained by inquiring information on components registered in the naming server 110.

Meanwhile, the naming server 110 releases the registration of the corresponding components when the release of the registration of the specific components among the registered components is requested.

The domain manager component 120 manages domains in the SCA-based system. At this time, the domain manager component 120 manages information on the device manager component 140 and the device component 150 that exist in the domains. In addition, the domain manager component 120 manages information on the service component (not shown), the application component (not shown), etc.

The domain profile describes a hardware device and a software component that configure the SCA-based system domain and includes a device configuration descriptor (hereinafter, referred to as ‘DCD’) file including information on all the components within the SDR terminal, a software package descriptor (hereinafter, referred to as ‘SPD’) file, a software component descriptor (hereinafter, referred to as ‘SCD’) file, and a properties descriptor (hereinafter, referred to as ‘PRF’) file, etc.

Herein, the DCD file essentially includes information on the device manager component 140 and defines the device information and the configuration information of the device. Further, the SPD file defines information for identifying objects to be implemented when implementing unit software components. Further, the SCD file defines interface and port information that provides or uses components and the PRF file defines detailed properties information on the devices.

At this time, the DCD file, the SPD file, the SCD file, and the PRF file, etc., are described in an eXtensible Markup Language (XML) file form.

In addition, the domain profile defines a directory including the device component 150 related file in the SCA-based domain system.

The device manager component 140 defines a method for installing the devices, a method for searching the domain manager component 120, etc. Therefore, the domain manager component 120 manages the information on the device component 150 according to contents defined by the device manager component 140.

In other words, the domain manager and the device manager component 140 manage the registration and release of the device component 150.

The domain manager parses the device manager component related file, that is, the SPD file, the SCD file, the PRF file from the DCD file included in the XML file when the system is operated to load, execute, and operate the device manager component 140. As such, the operated device manager component 140 loads, executes, and operates all the components included in the DCD file. At this time, the operated components register when the corresponding components are operated in the device manager component 140.

At this time, the device manager component 140 register the device component 150 managed by the device manager component 140 and the corresponding device manager component 140 in the domain manager component 120.

Meanwhile, the device manager component 140 arranges the device component 150 related file in the directory and when the new device component 150 is added, additionally arranges the new device component 150 related file in the directory, such that it changes and registers only the new device component 150 related file in the existing file.

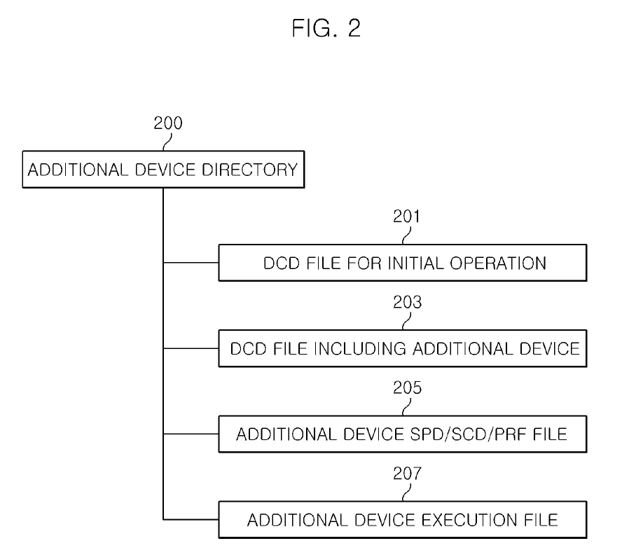

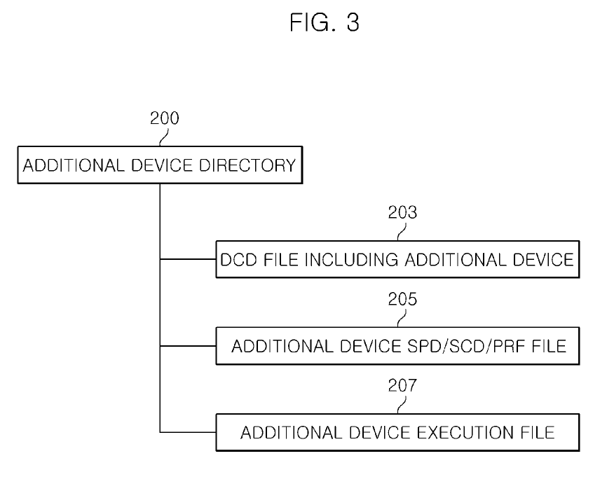

FIGS. 2 and 3 show a file directory structure in the SCA-based SDR terminal according to the present invention. In particular, when the device component 150 for an additional device is installed during the operation of the SDR terminal, FIGS. 2 and 3 show the file directory structure for copying and installing the corresponding device component 150 related file.

First, the device component 150 related XML file to be added is described in the domain profile. Herein, the XML file includes the SPD file, the SCD file, and the PRF file. Therefore, the SPD file, the SCD file, and the corresponding device component 150 PRF file are obtained from the XML file of the device component 150 to be added from the domain profile. At this time, the device manager component 140 copies the SPD file, the SCD file, and the PRF file obtained from the XML file and arranges them in the file directory.

In addition, the device manager component 140 extracts and copies the device component 150 related execution file to be added and arranges it in the file directory as described above.

The device manager component 140 finally copies the DCD file including the corresponding device component 150 and arranges it in the file directory. At this time, the device manager component 140 confirms the DCD file name to be added. The device manager component 140 compares the DCD file name to be added with the existing DCD file name for the initial operation. When the DCD file name to be added is different from the existing DCD file name, the device manager component 140 arranges the DCD file to be added, separately from the directory in which the existing DCD file is arranged, as shown in FIG. 2.

In other words, when the DCD file name to be added is different from the existing DCD file name, the file directory of the device component 150 to be added has a structure that includes a DCD file 201 for the initial operation, a DCD file 203 including the device component 150 to be added, a SPD/SCD/PRF file 205 of the device component 150 to be added, and an execution file 207 of the device component 150 to be added. Thereafter, the device manager component 140 removes the DCD file 201 for the initial operation.

Meanwhile, when the DCD file name to be added is identical with the existing DCD file name, the device manager component 140 replaces the existing DCD file with the DCD file to be added and then arranges it, as shown in FIG. 3.

In other words, when the DCD file name to be added is identical with the existing DCD file name, the file directory of the device component 150 to be added has a structure that includes, the DCD file 203 including the device component 150 to be added, the SPD/SCD/PRF file 205 of the device component 150 to be added, and the execution file 207 of the device component 150 to be added.

Thereby, when reconfiguring the components according to the mode change in the SCA-based system, only the corresponding device component 150 to be added is additionally installed and operated without re-operating all the components, making it possible to effectively manage the system resources. Further, there are advantages in that the installation time of the components due to the reconfiguration of the SCA-based system can be shortened and power consumption can be minimized.

In addition to the added device component 150, the state of the registration information of the continuously operated components is consistently maintained.

The operation of the present invention configured as described above will now be described.

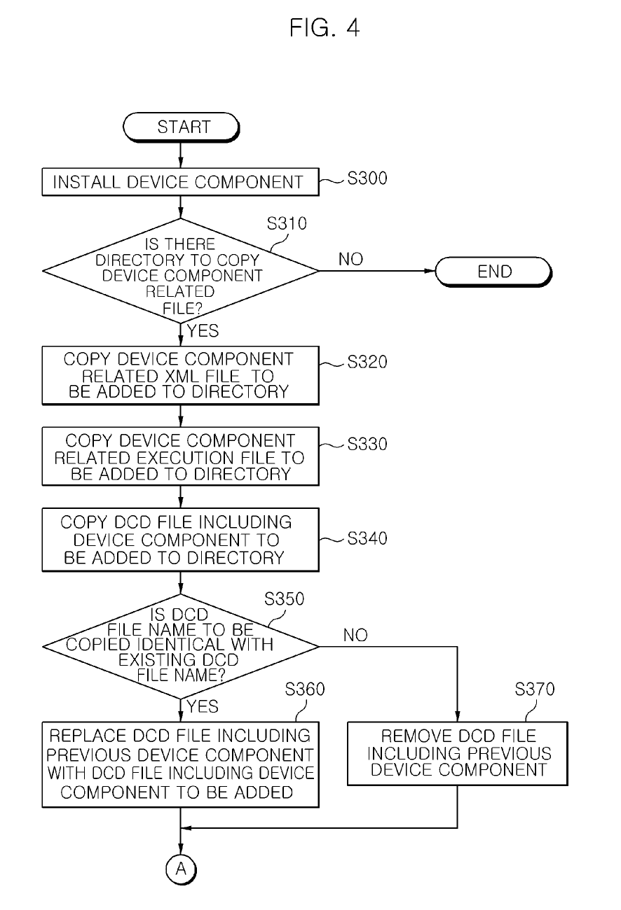

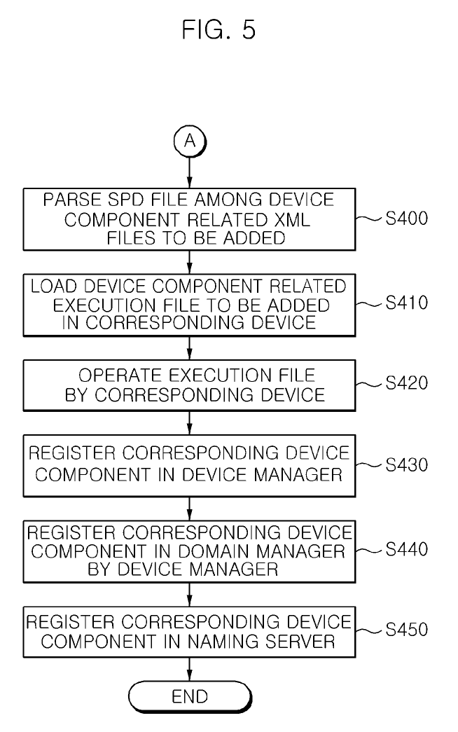

FIGS. 4 and 5 show flowcharts showing operational flows of a method for installing the new device component 150 in the SCA-based system according to the present invention.

Referring first to FIG. 4, when a mode change is requested (S300), the device manager component 140 executes an operation of installing the device component 150 corresponding to the requested mode (S310). At this time, the device manager component 140 determines whether there is a directory to copy the corresponding device component 150 related file (S320).

If it is determined that there is no directory to copy the corresponding device component 150 related file (S330), the device manager component 140 stops the operation of installing the corresponding device component 150. Of course, after requesting to configure the directory to copy the device component 150 related file, the operational flow may start from step ‘S300’ again.

On the other hand, if it is determined that there is a directory to copy the corresponding device component 150 related file (S330), the device manager component 140 copies the XML file of the corresponding device component 150 in the domain profile and arrange it in the file directory (S340). In addition, the device manager component 140 copies the execution file of the corresponding device component 150 to be added and arranges it in the file directory (S350). Further, the device manager component 140 copies the DCD file including the corresponding device component 150 and arranges it in the file directory (S360).

At this time, the device manager component 140 confirms the DCD file name including the corresponding device component 150. When the DCD file name including the corresponding device component 150 is identical with the DCD file name including the existing device component 150 (S370), the existing DCD file is replaced with the DCD file to be added, which is in turn arranged in the corresponding directory (S380).

Meanwhile, when the DCD file name including the corresponding device component 150 is different from with the DCD file name including the existing device component 150 (S380), the DCD file to be added is arranged in the corresponding directory and the existing DCD file is then removed from the directory (S390).

The device manager component 140 arranges all the corresponding device component 150 related files in the directory and executes steps after FIG. 5A.

Referring to FIG. 5, the device manager component 140 parses the XML file arranged in the file directory. Herein, the XML file includes the SPD/SCD/PRF files and the device manager component 140 parses the SPD file among the XML files during step ‘S400’ (S400).

The device manager component 140 loads the execution file extracted from the parsing results of the SPD file to the corresponding device component 150 (S410). Therefore, the corresponding device component 150 operates the execution file loaded by the device manager component 140 (S420).

The device manager component 140 registers the device component 150 that is being operated (S430) and registers it in the domain manager (S440). At this time, the domain manager is configured to initialize the corresponding device component 150.

Finally, the device manager component 140 registers its own device in the naming server 110 (S450). Thereby, the operation of installing the new device component 150 in the SCA-based SDR terminal system stops.

As described above, the apparatus for managing new device components of a mobile terminal and the method of the same according to the present invention are not limited to the configuration and method of the embodiments described as above, but the embodiments may be configured by selectively combining all the embodiments or some of the embodiments so that various modifications can be made.

What is claimed is:

1. An apparatus for managing new device components of a mobile terminal, comprising:
a domain profile that defines a component related file operated within a domain system of a corresponding mobile terminal;
a device component that manages devices within the domain system; and
a device manager component that reconfigures components within the domain system by arranging and managing the component related file defined in the domain profile as a file directory structure and additionally arranging a device component related file corresponding to the new device in the file directory at the time of changing a mode to the new device during the operation of the domain system.

2. The apparatus for managing new device components of a mobile device according to claim 1, wherein the device manager component stores the device component related file in the corresponding directory by confirming whether there is a directory for additionally arranging the device component related file of the new device in the file directory at the time of adding the new device.

3. The apparatus for managing new device components of a mobile device according to claim 2, wherein the device manager component additionally generates the file directory in which the device component related file is arranged when there is no directory for additionally arranging the corresponding device component related file.

4. The apparatus for managing new device components of a mobile device according to claim 1, wherein the device component related file includes at least one of a device configuration descriptor file, an XML file, and an execution file.

5. The apparatus for managing new device components of a mobile device according to claim 4, wherein the device configuration descriptor file includes at least one of initial operating information of the device manager components and new device information.

6. The apparatus for managing new device components of a mobile device according to claim 4, wherein the XML file includes a software package descriptor file, a software component descriptor file, and a properties descriptor file.

7. The apparatus for managing new device components of a mobile device according to claim 4, wherein the device manager component parallely arranges the device component descriptor file, the XML file, and the execution file in the corresponding file directory.

8. A method for managing new device components of a mobile terminal, comprising:
arranging and managing a component related file operated within a domain system of a corresponding mobile terminal as a file directory structure;
additionally arranging a device component related file corresponding to the new device in the file directory at the time of changing a mode to the new device during the operation of the domain system; and
operating the device components by executing the corresponding device component related file additionally arranged in the file directory.

9. The method for managing new device components of a mobile terminal according to claim 8, further comprising: prior to additionally arranging in the file directory, confirming whether there is a directory to additionally arrange the corresponding device component related file.

10. The method for managing new device components of a mobile terminal according to claim 9, further comprising: when there is a directory to additionally arrange the corresponding device component related file, copying the device component related file and storing it in the corresponding directory.

11. The method for managing new device components of a mobile terminal according to claim 9, further comprising: when there is no directory in which the corresponding device component related file is additionally arranged, additionally generating a file directory to arrange the device component related file.

12. The method for managing new device components of a mobile terminal according to claim 8, wherein the device component related file includes at least one of a device configuration descriptor file, an XML file, and an execution file.

13. The method for managing new device components of a mobile terminal according to claim 12, wherein the device configuration descriptor file includes at least one of initial operating information of the device manager components and new device information.

14. The method for managing new device components of a mobile device according to claim 12, wherein the XML file includes a software package descriptor file, a software component descriptor file, and a properties descriptor file.

15. The method for managing new device components of a mobile device according to claim 12, wherein the additionally arranging parallely arranges the device component descriptor file, the XML file, and the execution file in the corresponding file directory.
